(19) United States
(12) Patent Application Publication
(10) Pub. No.: US 2002/0004740 A1
(43) Pub. Date: Jan. 10, 2002

(54) Marketing data collection system and method

(76) Inventors: Michael J. Shotey, Scottsdale, AZ (US); Marcus J. Shotey, Scottsdale, AZ (US)

Correspondence Address: Albert L. Schmeiser, Schmeiser, Olsen & Watts LLp, 18 East University Drive, #101, Mesa, AZ, 85201, US

(21) Appl. No.: 09/900,663

(22) Filed: Jul. 6, 2001

Related U.S. Application Data
(60) Provisional application No. 60/216,920, filed on Jul. 8, 2000.

(51) Int. Cl. G06F 17/60

(52) U.S. Cl. 705/10; 705/14

(57) ABSTRACT

A marketing data collection system for collecting marketing data pertaining to a merchandiser at a target location having at least one display and transferring the marketing data to a data center. The system comprises a target location identifier code located at the target location, and a portable storage device including a code reader for reading and storing the target location identifier code and a data output device for transferring the target location identifier code to the data center. The system may include a token into which the target location identifier code is embodied. The token may comprise a magnetic strip, a magnetic bar code, an optical bar code, and the like. The portable storage device may include a clock for recording and storing a time at which the target location identifier code is inputted into the portable storage device.

The portable storage device preferably records and stores the date and time at which the merchandiser arrives at and departs from each target location, as well as individual product displays at each target location. The data output device may include a modem, an infrared output device, connection circuitry for connection to a telecommunication network, connection circuitry for connection to a cellular telecommunication network, and the like.

This application claims the benefit of U.S. provisional application, Ser. No. 60/216,920, filed on Jul. 8, 2000, which is incorporated herein by reference.

### BACKGROUND OF THE INVENTION

1. Technical Field

The invention relates to apparatus, systems and methods for collecting and communicating marketing data and, more specifically, to such apparatus, systems and methods employing electronic or computerized means.

2. Background Art

In wholesale and retailing industries, it is common for the wholesaler, distributor or retailer to present its own wares, and often those of other manufacturers or suppliers, at “displays.” The term “display” or “product display” as used herein can be used broadly to include a point or location at which a particular product or product line is displayed or exhibited for would-be-purchasers, brochures, etc. Displays may include point-of-sale displays, window displays, shelf locations, etc. A display also may involve presentation of a product or product line by sample or facsimile. Examples might include display of a product using a video or television monitor, a computerized presentation, and the like.

To illustrate the concept of a display, one may consider the example of a particular product handled by a hardware store. A point-of sale display may be placed at or near the entrance to the store to attract the attention of customers as they enter into the store. This point-of-sale display would constitute a first display for that product. A typical hardware store includes a large number of isles, with shelving at each isle displaying the various and sundry products offered by that store. The product also maybe presented to customers in a second, separated location by placing it on the shelves in the isle or isles and in the specific location where products of that type are displayed. This second location would constitute a separate display.

It is common in the wholesale and retail industries for manufacturers and/or distributors of products to enlist the services of a person, commonly referred to as a “merchandiser” to visit the stores in which that manufacturer's or distributor's products are handled, and to ensure that the products are properly and advantageously presented to consumers. The merchandiser, for example, would be assigned a set of stores that handle products or product lines of its employer. At each location, the merchandiser typically inspects each display at which the product or product lines in question are presented. The merchandiser may appropriately stock the products so that an adequate supply of inventory is available to consumers. The merchandiser also may clean, organize, and otherwise maintain the display so that it is attractive and functional to optimize its effectiveness in attracting purchasers and supporting sales of the product or product line. Th merchandiser may be an employee of the manufacturer or distributor, or he or she may be a separately employed contractor or agent for the manufacturer or distributor. It is not uncommon for merchandisers to represent a number of manufacturers and/or distributors, and a variety of products and product lines.

In addition to the aforementioned services, the merchandiser can benefit the manufacturer or distributor by providing marketing data, for example, in the form of information about consumer interest or lack of interest in a given display or display format, information gathered from store personnel regarding customer feedback, problems or frequent questions encountered by consumers relating to the product or its presentation, etc.

This general approach of using merchandisers to service products or product lines has been limited in the past, for example, in that the manufacturer or distributor does not have direct control over the merchandiser, and may have difficulty in ascertaining specifically the amount of time, effort and attention the merchandiser directs toward the manufacturer's or distributor's product line. The merchandiser or distributor also generally has been unable to reliably confirm the amount of time, effort, etc., the merchandiser directs toward a particular product, product line and/or display. There has been a need for greater quality and amounts of marketing data, for example, such as the amount of time the merchandiser spends at a particular store, the amount of time the merchandiser spends within the store at a particular display or location, and other information pertaining to the activities of the merchandiser.

Prior approaches also have been limited in that marketing data provided by the merchandiser to the manufacturer or distributor often has not been provided in a timely fashion. It is common for a merchandiser to cover a relatively wide geographic area. The merchandiser not uncommonly reports his or her activities and findings back to the manufacturer or distributor only periodically, for example, when the merchandiser has completed his or her rounds of stores and returns to the home office or central location where the manufacturer and/or distributor is located.

### DISCLOSURE OF INVENTION

Accordingly, an object of the present invention is to provide apparatus, systems and methods for efficiently collecting and communicating marketing data pertaining to a merchandiser.

Another object of the invention is to provide apparatus, systems and methods for providing accurate and timely information pertaining to the activities of a merchandiser.

Additional objects and advantages of the invention will be set forth in the description that follows, and in part will be apparent from the description, or many be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, marketing data collection systems and methods are provided for collecting marketing data pertaining to a merchandiser at a target location, or at a number of target locations. Each target location preferably but optionally includes at least one product display.

In accordance with one aspect of the invention, a marketing data collection system is provided for collecting marketing data pertaining to a merchandiser at a target location having at least one display, and transferring the marketing data to a data center. The system comprises a target location identifier code located at the target location and a portable storage device including a code reader for reading and storing the target location identifier code, and a data output device for transferring the target location identifier code to the data center. The system preferably includes a token located at the target location, in which instance the target location identifier code may be embodied in the token. The token may comprise a magnetic strip, a bar code such as an optical or magnetic bar code, a digital chip, and the like.

The portable storage device preferably includes a clock for recording and storing a time at which the target location identifier code is inputted into the portable storage device. The portable storage device may record and store the target location identifier code as a target location arrival time denoting arrival of the merchandiser at the target location. It also may record and store the target location identifier code as a target location departure time denoting departure of the merchandiser from the target location. The portable storage device optionally but preferably many include a processor that alternates between recording a target location arrival time and a target location departure time each time the target location identifier code is inputted into the portable storage device.

In preferred embodiments, the system may include a display identifier code at the at least one display; and the portable storage device could record and store the display identifier code as a display arrival time. The system also may include a display identifier code at the at least one display; and the portable storage device may record and store the display identifier code as a display departure time. The system also may include a display identifier code at the at least one display; and the portable storage device may include a processor that alternates between recording a display arrival time and a display departure time each time the display identifier code is inputted into the portable storage device.

The portable storage device preferably includes a code reader. The coder reader may comprise virtually any device capable of reading the target location identifier code and/or display identifier codes. Preferred examples would include a bar code reader, a magnetic code reader, a chip reader, and the like.

The data output device is adapted to communicate the stored marketing data to a data center. The data center may comprise a physical location or collection or network of locations spaced from the portable storage device at which marketing data is stored for use. The data center may comprise a distributed network, for example, involving a network of computers. Preferably but optionally, the data center comprises a single location at which a database computer, such as a server, would be located. The server may be and preferably would be a commercially available computer, such as a personal computer, configured with a commercially available database software package, adapted in known manner to store marketing data as described herein.

The data output device may induce a modem, an infrared output device, connection circuitry for connection to a telecommunication network, connection circuitry for connection to a cellular telecommunication network, and similar devices or means presently available or later developed.

Optionally, the portable storage device may include a receiver for receiving signals from a positioning system, such as a satellite positioning system.

In accordance with another aspect of the invention, a marketing data collection method is provided for collecting marketing data pertaining to a merchandiser at a target location having at least one display and transferring the marketing data to a data center. The method according to this aspect of the invention comprises a first step of recording and storing arrival of the merchandiser at the target location in a portable storage device as target location arrival data, and a second step of transferring the target location arrival data from the portable storage device to the data center. Preferably but optionally, the method further includes a third step of recording and storing departure of the merchandiser from the target location in the portable storage device as target location departure data, and the second step further includes transferring the target location departure data from the portable storage device to the data center.

The method also may include a fourth step of recording and storing arrival of the merchandiser at a first one of the at least one displays at the target location in the portable storage device as display arrival data, and the second step may further include transferring the display arrival data from the portable storage device to the data center. Also as an option, the method may include a fifth step of recording and storing departure of the merchandiser from a first one of the at least one display in the portable storage device as display departure data, and the second step may further include transferring the display departure data from the portable storage device to the data center.

Preferably, the first step includes use of a bar code reader operatively coupled to the portable storage device. According to preferred versions of the method, the first step may include positioning a target location bar code at the target location, the target location bar code including a target location identifier code; and using the bar code reader to read the target location bar code and thereby input the target location identifier code into the portable storage device. The third step of the method may include positioning a display bar code at the at least one display. The display bar code includes a display identifier code. The third step also many include using the bar code reader to read the display bar code and thereby inputting the display identifier code into the portable storage device.

The second step of this method may include transferring the target location arrival data and the target location departure data to the data center using a remote data transmission. The remote data transmission step may include using a telecommunication network, a cellular telephone network, a satellite communication system, and the like, as now known or later developed.

The first step of the method may include using a positioning system for providing the position of the merchandiser. It may include, for example, using a satellite positioning system to identify and designate the target location.

In accordance with another aspect of the invention, a portable storage device is provided for collecting marketing data pertaining to a merchandiser. The device comprises a code reader for reading and storing a target location identifier code, and a data output device for transferring the target location identifier code to the data center. The code reader may comprise a magnetic strip reader, a bar code reader, an optical bar code reader, a magnetic bar code reader, and the like, as now known or later developed.

The device preferably includes a processor that alternates between recording a target location arrival time and a target location departure time each time the target location identifier code is inputted into the portable storage device. The device also preferably includes a clock for recording and storing at time a at which the target location identifier code is inputted into the portable storage device. The data output device of the portable storage device preferably but optionally includes a modem. The data output device also may include connection circuitry for connection to a telecommunication network, connection circuitry for connection to a cellular telecommunication network, transmit circuitry for transmitting the marketing data to a satellite, and the like.

The portable storage device optionally may include a receiver for receiving signals from a positioning system, such as a receiver for receiving signals from a satellite positioning system.

In accordance with another aspect of the invention, a marketing data collection method is provided for collecting marketing data pertaining to a merchandiser at a target location and transferring the marketing data to a data center. The method comprises a first step of using a token located with the merchandiser to record and store arrival of the merchandiser at the target location in a storage device as target location arrival data. The storage device is located at the target location. The method also includes a second step of transferring the target location arrival data from the storage device to the data center by remote data transmission.

This method may include a third step of using the token to record and store departure of the merchandiser from the target location in the storage device as target location departure data, and the second step may further include transferring the target location departure data from the storage device to the data center. The token preferably includes a bar code, and the first step preferably include using a bar code reader embodied in the storage device to read the token. The token may include a magnetic code, wherein the first step would include reading the magnetic code. The token also may include an optical code, and the first step would include reading the optical code. The token also may include a fingerprint of the merchandiser, and the first step would include reading a fingerprint of the merchandiser. The token also may include an electromagnetic transmitter that transmits an electromagnetic signal, in which event the first step would include reading the electromagnetic signal. The token also may include an optical transmitter that transmits an optical signal, in which event the first step would include reading the optical signal.

The remote data transmission step according to this aspect of the invention may include using a telecommunication network, a cellular telephone network, a satellite communication system, and the like, as now known or later developed.

In accordance with another aspect of the invention, a marketing data collection method for collecting marketing data pertaining to a merchandiser at a target location and transferring the marketing data to a data center. The method comprises a first step of recording and storing arrival of the merchandiser at the target location in a storage device as target location arrival data, and a second step of automatically transferring the target location arrival data from the storage device to the data center.

Optionally but preferably, the method further includes a third step of recording and storing departure of the merchandiser from the target location in the storage device as target location departure data, and the second step further includes automatically transferring the target location departure data from the storage device to the data center.

The third step of the method may include transferring the target location arrival data and the target location departure data to the data center using a remote data transmission. The remote data transmission step may include using a telecommunication network, a cellular telephone network, a satellite communication system, and the like, as now known or later developed.

### BRIEF DESCRIPTION OF THE DRAWINGS

The accompanying drawings, which are incorporated in and constitute a part of the specification, illustrate presently preferred embodiments and methods of the invention and, together with the general description given above and the detailed description of the preferred embodiments and methods given below, serve to explain the principles of the invention.

FIG. 1 is a pictorial diagram illustrating a first preferred embodiment of a marketing data collection system according to one aspect of the invention, and useful for illustrating the preferred method according to another aspect to the invention;

FIG. 2 shows an illustrative bar code used as part of the system illustrated in FIG. 1 and as part of the preferred methods;

FIG. 3 is a perspective view of a remote according to the first preferred embodiment as illustrated in FIG. 1, and for use in the preferred methods;

FIG. 4 is a top end view of the remote shown in FIG. 3;

FIG. 5 is a block diagram of internal components of the remote shown in FIG. 3;

FIG. 6 is a flow diagram illustrating processing that occurs in the remote shown in FIG. 3, and that occurs as part of the preferred methods, in recording and storing marketing data;

FIG. 7 is a flow diagram illustrating processing that occurs in the remote shown in FIG. 3, and that occurs as part of the preferred methods, in transferring marketing data recorded and stored in the remote (FIG. 3) to a data center;

FIG. 8 is a pictorial diagram illustrating a second preferred embodiment of the system according to one aspect of the invention, and useful for illustrating the preferred method according to another aspect of the invention, and useful for illustrating the preferred method according to another aspect of the invention;

FIG. 9 is a perspective pictorial diagram illustrating an embodiment according to another aspect of the invention; and

FIG. 10 is a block diagram of the embodiment shown in FIG. 9.

### DETAILED DESCRIPTION OF THE PREFERRED EMBODIMENTS AND METHODS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

In accordance with one aspect of the invention, a marketing data collection system is provided for collecting marketing data pertaining to a merchandiser at a target location having at least one display and transforming the marketing data to a data center. “Target location” as the term is used herein refers to any physical location at which a display or displays for a product or product line are disposed. The target location typically would be a wholesale or retail store or outlet, a showroom, an exhibition site, etc. Reference will be made below to the target location as a store, but this is intended to be merely illustrative and not limiting.

“Merchandiser” as the term is used herein can be interpreted broadly to include any person or organization that travels to the individual target location or locations and provides a service related to that display or displays, product or product line, etc. The services may include those described summarily above, such as stocking product, cleaning or organizing the display, installing, dismantling, or modifying a display, collecting information abut consumer reactions or responses to the display, the product, or the product line, etc.

The system according to this aspect of the invention comprises a target location identifier code located at the target location. The target location identifier code comprises marketing data in the form of a number, a character string, or other storable and retrievable data structure that identifies the particular target location.

The system according to this aspect of the invention preferably comprises a token located at the target location, into which the target location identifier code is embodied. The token may, for example, comprise a magnetic strip, a bar code (optical, magnetic, etc.), a digital chip, etc.

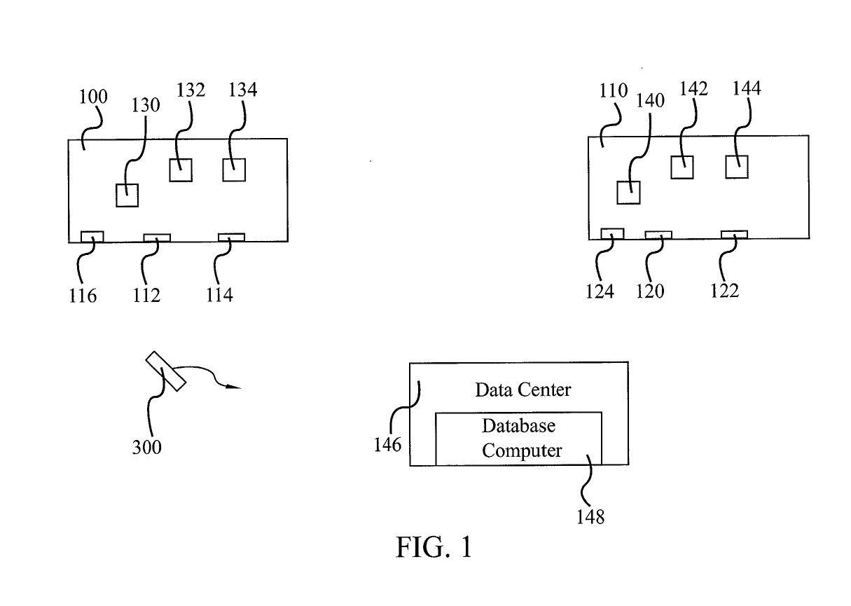

A presently preferred embodiment of the system according to this aspect of the invention is illustrated in FIG. 1. In accordance with this preferred embodiment, the target location identifier code is a series of digits that are incorporated into an optical bar code physically and fixedly located at the target location. With reference to FIG. 1, the system according to the preferred embodiment can illustratively be envisioned as operating in connection with a first target location 100 and a second target location 110. Each of these target locations, for example, may comprise a wholesale or retail outlet, such as a hardware store.

Target location 100 includes a customer entrance 112 and store exit 114, which of course could be one and the same. In accordance with this preferred embodiment, a token in the form of a bar code 116 which incorporates the target location identifier code is physically located near entrance 112 of store 100. This is not necessarily limiting, however, and may be located anywhere in or at the target location.

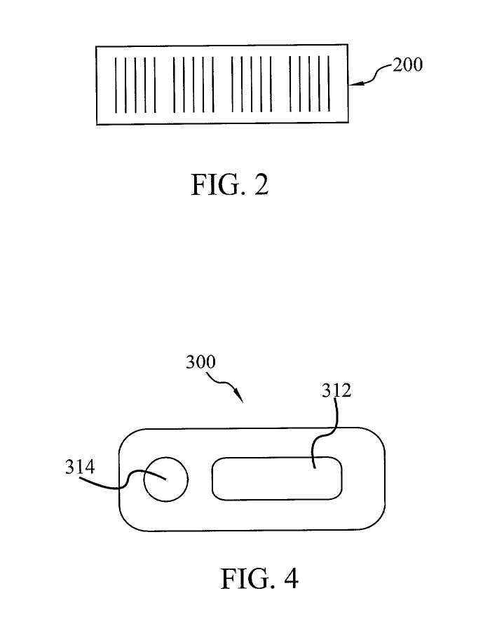

Bar code 116 may comprise an optically-read bar code, an example of which is identified by reference numeral 200 in FIG. 2. It should be noted, however, that the target location identifier code may be embodied in other forms. Examples would include a magnetic bar code, a magnetic digital or analog storage medium such as a magnetic strip as is commonly provided on credit cards, a digital chip, and the like, etc.

Store (second target location) 110 similarly includes an entranceway 120, an exit 122, and a bar code 124 identical to bar code 116, except for the fact that the target location identifier code of bar code 124 would identify store 110 rather than store (first target location) 100. The options available for bar code 124 are the same as those for bar code 116.

The system according to this aspect of the invention further includes a portable storage device or means including a code reader or code reading means for reading and storing the target location identifier code, and a data output device or data output means for transferring the target location identifier code to the data center.

In accordance with this preferred but illustrative embodiment, the portable storage device and portable storage means comprises a hand-held remote 300; preferably approximately the size of a hand-held calculator or cellular telephone. Externally, remote 300 includes a numeric key pad 302, a function key area or region 304 and a display window 306. A serial port connector 308 is disposed in the base end 310 of remoter 300. With reference to FIG. 4, remote 300, and specifically the code reader means, include an optical bar code reader window 312 and a retractable antenna 314. A parallel port connector 316 also may be provided where parallel data transmissions are desired.

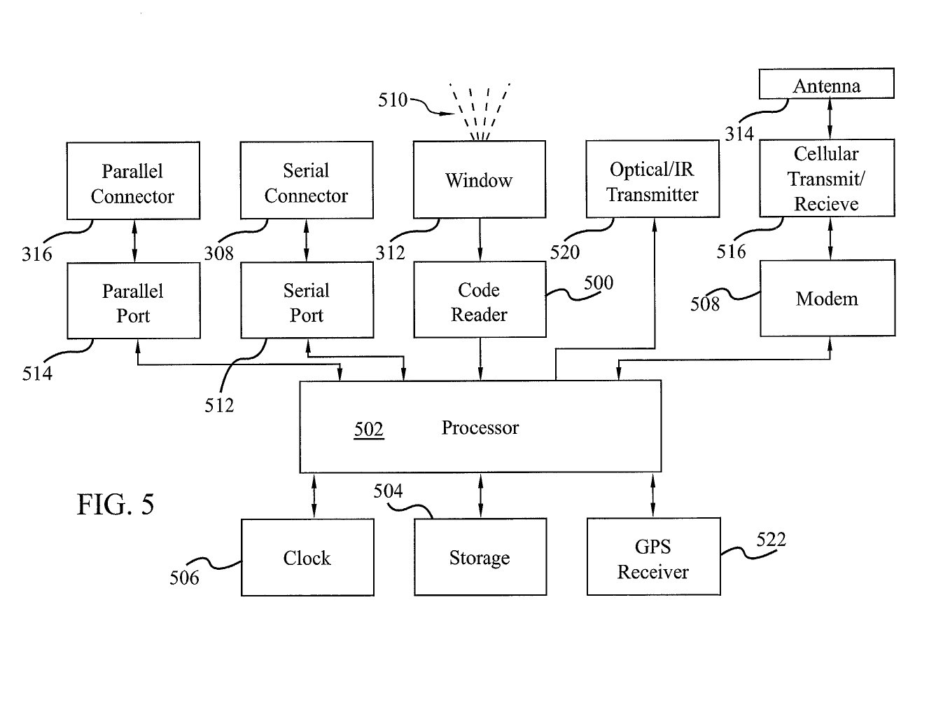

The internal structure of remote 300 is depicted in schematic form in FIG. 5. As illustrated there, remote 300 includes code reading means in the form of a code reader 500, processing means in the form of a processor 502, storage means in the form of storage device 504, clock means in the form of a clock 506, and data transmitting means in the form of a modem 508. Code reader 500 may take a number of forms, depending on the specific format and media of the codes read by remote 300. In accordance with this preferred system embodiment, code reader 500 comprises an optical bar code reader for scanning bar codes such as bar codes 116 and 124. The internal structure and design of code reader 500 can be in accordance with bar code readers currently available commercially. Code reader 500 includes an optical source (not shown) which transmits an optical beam 510 through code reader window 312 and outwardly away from remote 300. When remote 300 is positioned adjacent to and directed towards bar code 116 or 124, optical beam 510 propagates to the bar code and scans across it. The beam is reflected off of the bar code as it is scanned, and returns the mirrored optical beam back into window 312 and into opto-electrical transducers within code reader 500 (not shown) to generate digital data comprising the target location identifier code.

Processor 502 preferably comprises a commercially-available microprocessor, such as a PENTIUM® processor chip, commercially available from Intel Corporation of Santa Clara, Calif. Processor 502 preferably comprises a general microprocessor programmed to perform the functions herein described.

Processor 502 is coupled to code reader 500 to receive the digitized data read by code reader 500, e.g., the digitized target location identifier code. Clock 506 provides digital clock pulses or clock data so that, in conjunction with processor 502, they record and store a time at which the target location identifier code is inputted into the portable storage device. This provides time tagging and/or addressing of all data as it is inputted from code reader 500.

Processor 502 is operatively coupled to storage device 504 so that storage device 504 receives the time-stamped data from processor 502. Storage device 504 may comprise essentially any storage device, media or format that is operable with processor 502. The presently preferred storage device comprises random access memory (“RAM”) (not shown). Remote 300, in addition to modem 508, also includes a serial port 512, a parallel port 514 and a cellular transmitter and receiver 516.

Referring back to FIG. 1, a product display 130 is located adjacent to entrance 112 of store 100. A product display 132 for a first line of products, and a product display 134 for a second line of products also are located within store 100. In store 110, a product display 140 is located adjacent to entranceway 120, and product displays 142 and 144 are located within store 110 at separate locations to display respective product lines.

In accordance with this preferred system embodiment, a display identifier code is located at each of the product displays 130, 132, 134, 140, 142 and 144. Each product display identifier code according to this embodiment comprises a token in the form of a bar code that includes a display identifier code uniquely identifying the particular product display, or group or class of displays. Each display bar code comprises a bar code essentially identical to bar code 200 (FIG. 2), but, of course, with its own unique display code or number. The respective display bar codes thus may be scanned and read by code reader 500 of remote 300.

In accordance with this aspect of the invention, the portable storage device or means preferably comprises means to record and store the target location identifier code as a target location arrival time denoting arrival of the merchandiser at the target location. This can be implemented in a number of ways. An “arrival” function key 318 can be provided on remote 300, for example, in function key area 304, to indicate that the entry of data from a target location bar code represents arrival at that location. Similarly, keypad 302 can be used to enter this information.

The system according to this aspect of the invention may be implemented in a way that only arrival times are recorded. Preferably, however, the system records both arrival times and departure times from each target location, and optionally from each display. Accordingly, the portable storage device preferably records and stores the target location identifier code as a target location departure time denoting departure of the merchandiser from the target location. This may be implemented, as described above, for example, by selecting a “departure” function key 320 on remote 300 function keys 304, or by entering this information using keypad 302.

Preferably, the processor alternates between recording a target location arrival time and a target location departure time each time the target location identifier code is inputted into the portable storage device. As implemented in the preferred system embodiment according to this aspect of the invention, remote 300, and particularly processor 502, is adapted to record and store data read by code reader 500, e.g., the target location identifier codes and display identifier codes, alternately as arrival and departure data. For example, the first time that remote 300 is used to record target location identifier code 116, remoter 300 records this code as a target location arrival code, e.g., the time at which the merchandiser arrives at target location 100. The next time remote 300 is used to scan bar code 116, it records and stores the data as a target location departure, code, e.g., the time at which the merchandiser departs from target location 100. The next time remote 300 is used to scan the target location bar code, e.g., 116, it is read as a target location arrival code, and so on.

In accordance wit this aspect of the invention, the system preferably also includes a display identifier code at the at least one display, and the portable storage device records and displays the display identifier code as a display arrival time. As with the preferred system implementation for the target location identified code, the recording of the display identifier code as a display arrival time can be accomplished using “arrival” function key 318, or entering the information using key pad 302.

Although the system may be adapted to record only arrival information as to displays, preferably it is adapted to record both arrival at and departure from the product display. Accordingly, the system preferably includes a display identifier code at the at least one product display, and the portable storage device records and stores, or is capable of recording and storing, the display identifier code as a display departure time. This can be done, once again, using “departure” function key 320, or using key pad 302.

The system also may record presence of the merchandiser at a target location and/or product display, instead of or in addition to arrival and/or departure from them. Arrival at or departure from a target location or product display is tantamount to presence at it. Accordingly, as described above, recordation of arrival data or departure data can comprise recordation of presence data, reflecting presence of the merchandiser at the target location or product display. Similarly, presence at the target location or product display may be recorded at any point between arrival and departure.

Preferably, the system records both arrival and departure data by alternating between the two each time a display identifier code is entered. For example, the first time remote 300 is used to record a given one of the display bar codes, e.g., display bar code 130, the data is read as a display arrival code, e.g., the time at which the merchandiser arrives at display 130. The next time remote 300 is used to scan the display bar code for that display, remote 300 records and stores the display identifier code as a display departure code, e.g., the time at which the merchandiser departs from that display. The next time remote 300 is used to scan that display bar code, it is read as a display arrival code, and so on. By automatically recording the data for a given target location or display as arrival data and departure data in this manner, the design of the portable storage device can be simplified, its cost can be reduced, and its operation can be simplified.

It should be noted that the system format for the identifier codes and the code reader may take forms other than those expressly disclosed above. For example, one may use a chip reader, wherein the merchandiser would carry a portable digital chip device, and a corresponding chip reading device may be incorporated into remote 300 as part of code reader 500. Such chip readers are commercially available from a number of suppliers. An example would comprise a Duratrax hand-held device, commercially available from Videx, Inc. of Corvallis, Oreg. The Duratrax device comprises a memory button that is designed to interact with a corresponding button. The device is programmed so that, when the memory button is activated, records the particular merchandiser involved, the date and time at which the activation occurs, and the target location at which the activation occurs. Other information may be recorded as well, depending on the specific application and the needs or desires of the user. Separate arrival and departure times also may be recorded, as noted herein.

The system according to its preferred embodiments is adapted to communicate or transfer the marketing data, including target location identifiers (arrival and departure data) and product display identifiers (arrival and departure data) to a data center. As noted above, the term, “data center” may be construed broadly to include not only individual locations, but collections or networks or storage or data recipient locations. The data center may include a single database computer, a plurality of database computers, a database computer network, etc. The data center also may comprise, for example, an Internet or World Wide Web site or the like. As depicted in FIG. 1, and according to the preferred system embodiment and methods, the data center comprises a single location 146 and includes a database computer 148, the latter of which includes a commercially available database server as part of a Web-based system or site.

The system according to this aspect of the invention, and specifically the data output device, can transfer the marketing data stored in the portable storage device to the data center by a number of means. One such means involves use of a modem. As shown with regard to the preferred embodiment, remote 300 includes modem 300 for communicating with external devices. The modem may be connected by known techniques to a network, such as a local area network, a wide area network, a telecommunications network, and the like.

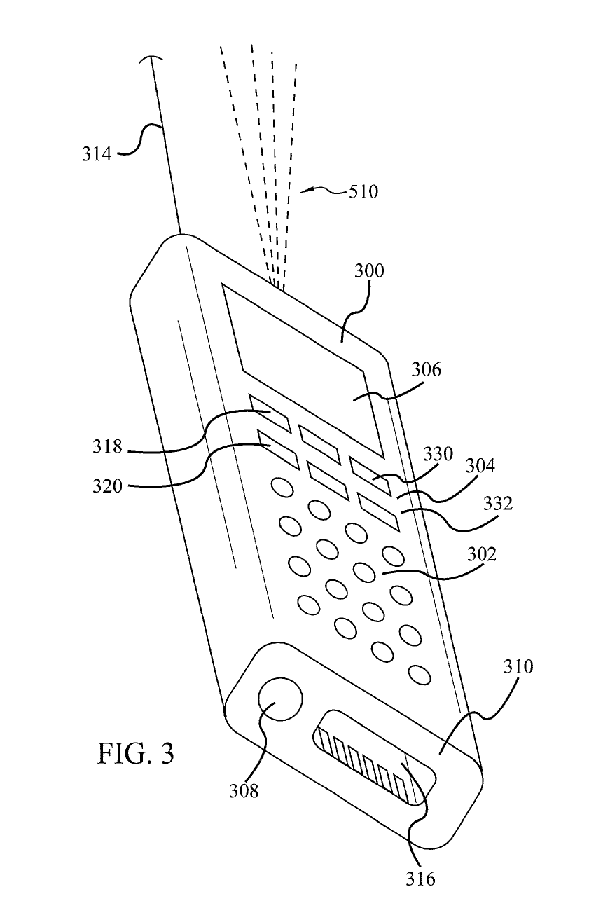

The data output device also may include connection circuitry for a connection to a cellular communication network. In connection with the preferred embodiment shown in FIGS. 3-5, for example, cellular transmitter/receiver 516 is provided for this purpose. In operation, remoter 300 would be programmed to place a call and establish a communication link with the data center. The signals would be transmitted from antenna 314 to the receiving antenna of the network. The communication link would be established in known fashion according to the well-established principles of cellular communications technology, and as commonly used in existing cellular telephone technology and wireless digital transmission technology. Once the link is established, the marketing data stored in remote 300 would then be transmitted via the telephone link to the database computer in the data center. The invention is not necessarily limited to transmission using these techniques. It is possible, for example, to provide a communication link between the portable storage device and the data center using a satellite. In this instance, signals would be transmitted from antenna 314 to a satellite appropriately configured to received the signal and repeat it to a down link to the data center.

The data output device also may include an infrared output device 520 (FIG. 5). This infrared output device, for example, would transmit an infrared beam outwardly from remoter 300 and toward a corresponding infrared receiver (not shown), for example, located at a terminal within the target location. The data at this infrared receiving terminal then could be transmitted to the data center using known data communication techniques. Similarly, the beam may be in the optical range, rather than infrared, e.g., as indicated in FIG. 5.

As an additional option, the system according to this aspect of the invention could employ a positioning receiver or system to provide position data to the portable storage device, e.g., so that the location of the target location is automatically read into the portable storage device when the merchandiser takes the portable storage device to the target location. This could eliminate, or supplement, the bar code reader or other token at the target location. A preferred example of a positioning receiver would be a satellite positioning system receiver, such as a Global Positioning System (“GPS”) receiver. As implemented in the preferred system embodiment according to this aspect of the invention, remote 300 is provided with a GPS receiver 522 (FIG. 5).

The system according to this aspect of the invention optionally may be operatively coupled to a computer system or network within a target location, or as used by a number of target locations, to interact with such target location system. Many large retailers, for example, have in-store computers that are used by the retailer to track inventory, conduct purchasing, etc. Systems according to the present invention can be used in conjunction with such systems, for example, by retrieving data, such as store-recorded inventory data, sales data, etc., for the product or products in question. This can be used by the merchandiser, for example, in servicing the displays, ordering additional product, etc. Similarly, systems according to the invention also may be used in conjunction with such in-store computer systems or networks to transfer to the latter information regarding product placed in the store, on-shelf inventories, etc.

In accordance with another aspect of the invention, a marketing data collection method is provided for collecting marketing data pertaining to a merchandiser at a target location having at least one display and transferring the marketing data to a data center. The method in general terms includes a first step of recording and storing arrival of the merchandiser at the target location in a portable storage device as target location arrival data, and a second step of transferring the target location arrival data from the portable storage device to a data center.

The method according to this aspect of the invention may be carried out by recording and storing only arrival data. It also may be carried out by recording and storing only target location identifier data. Preferably, however, the method includes recording and storing both arrival data and departure data for both target locations and product displays.

The method according to this aspect of the invention may be implemented in a variety of ways. For ease and simplicity of illustration, however, it will be described with reference to the preferred system embodiment as described above. It should be appreciated, however, that the method is not limited to this specific system or apparatus, and may be practiced or implemented with other systems and devices.

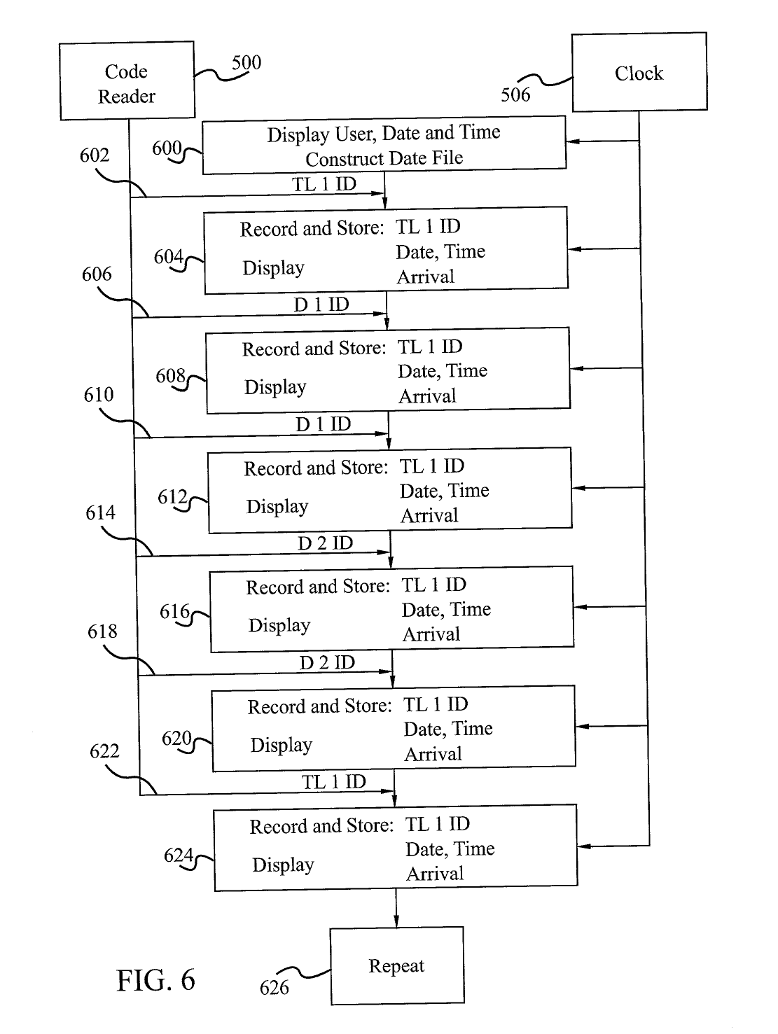

A presently preferred implementation of this method is illustrated in FIG. 6, which provides an outline of the steps in this preferred method in flow diagram format. The preferred manner of carrying out this method will be described with regard to the target location and display layout presented in FIG. 1. Again, however, it should be noted that this is not limiting.

With reference to FIG. 6, the merchandiser (not shown) begins the method, e.g., begins the day, by initiating remote 300 (turning on the power). This causes display 306 of remote 300 to display the user (the merchandiser's identification), the date, and the time. It also causes remote 300 to construct a date file for that date. This is shown in FIG. 6 by block 600.

In accordance with the preferred method, the first step includes recording and storing arrival of the merchandiser at the target location in a portable storage device as target location arrival data. The merchandiser accordingly proceeds to target location number 1. As part of the method, a target location identifier code, e.g., a token in the form of a bar code encoding the target location identifier code, is positioned at the target location. The merchandiser then uses remote 300, and specifically code reader 500 of remote 300, to read bar code 116. This causes the target location identifier code (TL 1 ID) to be read and inputted into processor 502 of remote 300, as indicated at 602.

As outlined above, remote 300 may be used to specifically input the fact that the inputted data constitutes “arrival” data, e.g., using function key 318 or keypad 302. Preferably, however, processor 502 compares its memory, or its pre-stored data for that date to determine whether target location identifier code TL 1 ID has been entered. Determining that code TL 1 ID has not been previously read on that date, processor 502 causes code TL 1 ID to be stored as “target location arrival data,” along with the date and time. This information is displayed on remote display 306, as indicated at 604. The method as an option may use a positioning system, and preferably a satellite positioning system, for input of the target location identifier code, as noted above with regard to the preferred system embodiment.

The preferred method further includes a step of recording and storing arrival of the merchandiser at a first one of the at least one displays at the target location in the portable storage device as display arrival data. This may be done by using remote 300, and specifically code reader 500 of remote 300, to read the bar code or other token at the product display. A display bar code that incorporates a display identifier code is positioned at the at least one product display, and preferably at each product display to be serviced by the merchandiser. With reference to the drawing figures, the merchandiser proceeds to product display 130, at which he or she uses remote 300 to scan the bar code at display 130. As indicated in FIG. 6 at 606, this causes the display identifier code for display 130 to be inputted via code reader 500 into processor 502. Although manual designation of the display data as “arrival data may be used, e.g., using function key 318 or keypad 302, preferably processor 502 compares this code with previously stored data for that date, and upon confirming that display code identifier D 1 ID has not been previously entered, stores this identifier code as “display arrival data,” along with the date and time, as indicated at 608. This information is displayed on display 306.

The method according to this aspect of the invention also preferably includes a step of recording and storing departure of the merchandiser from the first one of the at least one product displays in the portable storage device as display departure data. This may be done, e.g., in the manner described above for manual entry. To further illustrate with reference to the drawing figures, the merchandiser proceeds to inspect, service, etc., product display 130. When the merchandiser has completed his or her tasks and is prepared to depart product display 130, he or she again uses remote 300 to read the bar code at display 130. As illustrated in FIG. 6 at 610, this causes display identifier code D 1 ID to be inputted via code reader 500 to processor 502. Processor 502 then compares this code with the pre-stored data, and confirms that code D 1 ID has been previously stored on that date as display arrival data. Processor 502 therefore records and stores code D 1 ID as display departure data, together with the date and time, as indicated in FIG. 6 at 612. This data is displayed in remote display 306.

The merchandiser then proceeds from product display 130 to product display 132. The same steps as previously described are repeated. The merchandiser uses remote 300 to scan the bar code at product display D 2 ID. This causes code reader 500 to input into processor 502 display code D 2 ID, together with the date and time, as indicated at 614. Using the processing described above, processor 502 confirms the absence of a previous code D 2 ID entry, and therefore records and stores the code as “display arrival data.” The information, incidentally also may be entered manually if that implementation is preferred for a given application. This data is displayed in remote processor 306, as indicated in FIG. 6 at 616.

When the merchandiser completes his or her tasks at display 132, remote 300 is used once again to read the bar code at display 132. As indicated in FIG. 6 at 618, this causes display identifier code D 2 ID to be entered via code reader 500 to processor 502. Using processing as previously described, processor 502 confirms that this data represents the departure of the merchandiser from display 132, and therefore records and stores the data as display departure data, with the date and time, as indicated at 620. The data is displayed in remote display window 306.

Although not expressly illustrated in FIG. 6, this process could be continued for product display 134, and any other product displays present at that target location.

The preferred method further includes a step of recording and storing departure of the merchandiser from the target location in the portable storage device as target location departure data. With reference to the illustrative drawing figures, upon completing servicing of the product displays within target location 1, the merchandiser then proceeds back to target location 1 bar code 116, and uses remote 300 to read that bar code. Using the processing previously described, and as shown in FIG. 6 at 622, this causes target location identifier code TL 1 ID to be entered via code reader 500 to processor 502. Using processing as described above, processor 502 confirms that code TL 1 ID has been entered as target location arrival data, processor 502 therefore records and stores code TL 1 ID, together with the date and time as target location departure data, as shown in FIG. 6 at 624. This data is displayed on remote display window 306.

The method according to this aspect of the invention includes the step of transferring the marketing data to a data center. As part of that method, data collected as described above, whether it be target location data or display data, and arrival data or departure data, is transferred from the portable storage device to a data center, and preferably to a database computer as described above.

This transmission preferably is accomplished using remote data transmission, such as through the use of a telecommunications network, a cellular telephone network, a local area network, a wide area network, etc. Remote data transmission also may be achieved via a satellite.

As the merchandiser travels to each new target location, this process is repeated to record target location arrival and departure data and product display arrival and departure data. This is indicated generally in FIG. 6 at 626.

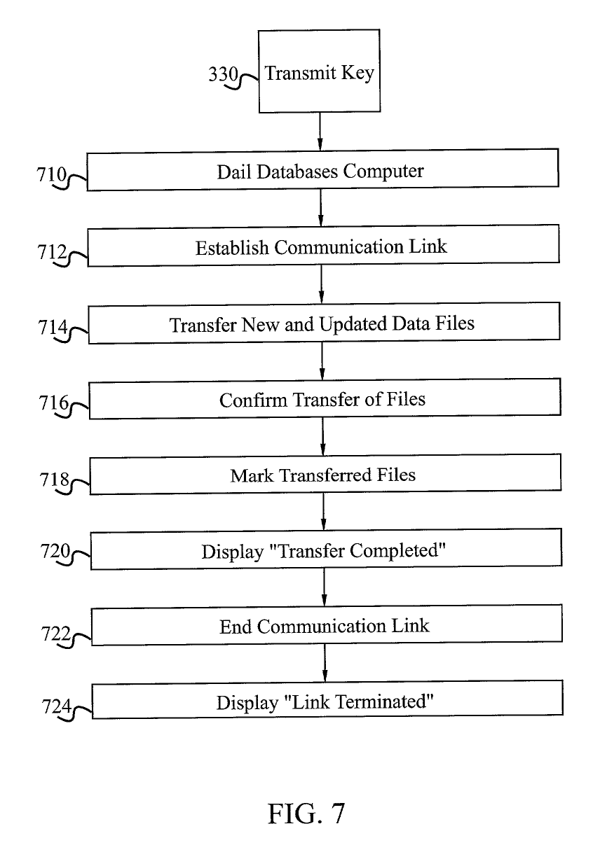

At a desired point, or at a predetermined time or circumstance, the marketing data stored in remote 300 is transferred to a data center, and preferably to a database computer (or computers). An illustrative summary of the processing that occurs in remote 300 in transferring stored marketing data to the data center is shown in FIG. 7. This process may be initiated in a number of ways, but in accordance with the preferred system embodiment is initiated by selection of a “transmit” function key 330 in function keys 304 of remote 300. Upon actuation of “transmit” function key 330, processor 502 causes modem 508 to dial up database computer 148, as indicated at 710. Modem 508 then proceeds to establish a communication link with database computer 148 in known manner, as indicated generally at 712. Once the communication link is established, processor 502 of remote 300 then causes all new and/or updated marketing data files stored in remote 300 to be transferred to database computer 148, as shown in FIG. 7 at 714. When remote 300 has completed the file transfer process, it then queries database computer 148 to confirm that the transfer of files has been completed successfully, as indicated at 716. Upon receiving confirmation from database computer 148, processor 502 of remote 300 then marks all files thus transferred to indicate that these files in fact have been transferred to database computer 148, as indicated at 718. This marking process may be used advantageously to quickly ascertain which files are new or have been updated, according to block 730. Upon completion of this transfer process, processor 502 causes “transfer completed” or like message to be displayed on display 306, as indicated at 720. Remote 300, and specifically modem 508, then terminates the communication link, as indicated at 722. Processor 502 then causes “Link Terminated” or like message to be displayed on display 306, as indicated at 724.

In accordance with another aspect of the invention, a marketing data collection method is provided for collecting marketing data pertaining to a merchandiser at a target location and transferring the marketing data to a data center. This method includes a first step of using a token located with the merchandiser to record and store arrival of the merchandiser at the target location in a storage device as target location arrival data, wherein the storage device is located at the target location, and a second step of transferring the target location arrival data from the storage device to the data center by remote data transmission. The method optionally may include a step of using the token to record and store departure of the merchandiser from the target location in the storage device as target location departure data, in which instance the second step would further include transferring the target location departure data from the storage device to the data center.

The token according to this aspect of the invention may include a bar code, a magnetic code, an optical code, and the like. The first step correspondingly and respectively would include using a bar code reader, a magnetic code reader, and/or an optical code reader to read the respective codes. The fingerprint or fingerprints of the merchandiser, or other identifier also may be used as the token.

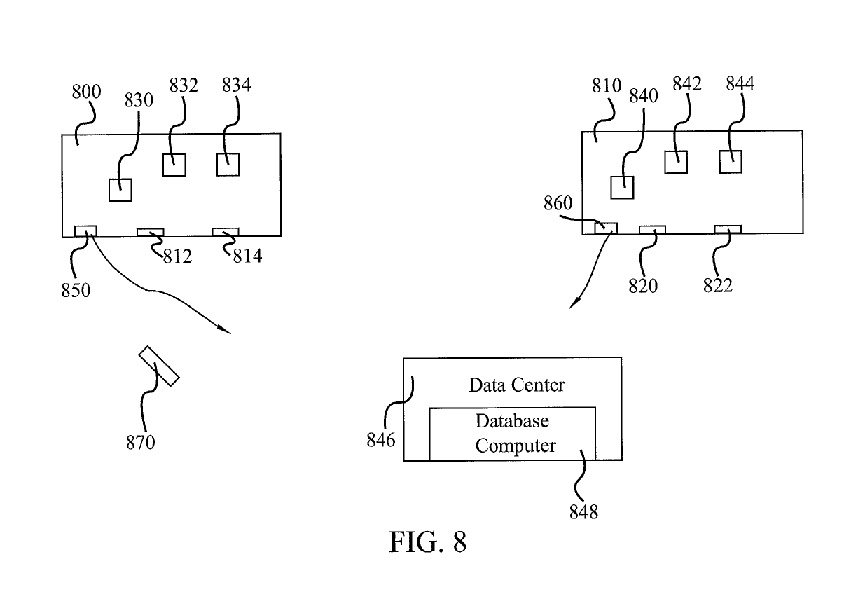

A preferred system and method according to this aspect of the invention is illustrated in FIG. 8. As illustrated there, a first target location 800, which includes entranceway 812, exit 814, and product displays 830, 832 and 834, also includes a code reader 850. Although code reader 850 may take a number of forms, in this preferred method and system it comprises a bar code reader for optically reading bar codes of the type shown in FIG. 2. Similar bar code readers also could be placed at product displays 830, 832 and 834.

A second target location 810, which also includes entranceway 820, exit 822, and product displays 840, 842 and 844, includes a code reader 860 identical to code reader 850.

In accordance with this preferred system and method, a token is located with the merchandiser. The token in this illustrative example comprises an optical bar code 870, as shown in FIG. 2. The bar code 870 may be affixed to or incorporated in a plastic card, a key ring attachment, or similar support device.

In use, the merchandiser, who carries bar code 870 on his or her person, arrives at first target location 800, whereupon he or she uses bar code 870 in conjunction with bar code reader 850 to read bar code 870 into code reader 850. This causes bar code reader 850 to record and store data indicating that the merchandiser has arrived at first target location 800. The merchandiser then may proceed to product displays 830, 832 and/or 834 for routine servicing. If code readers have been provided at these product displays, the merchandiser uses bar code 870 to cause it to be scanned by the respective code readers, thereby recording and storing at those code readers the fact that the merchandiser has arrived, and subsequently departed from those displays. As a modification, the respective code readers, including code reader 850, may be adapted to provide the data to a central storage device located within first target location 800. This may be done, for example, by remote transmission, such as by cable or wire, radio transmission, infrared transmission, and the like.

When the merchandiser has completed his or her tasks at first target location 800, the merchandiser preferably but optionally then uses bar code 870 with bar code reader 850 once again to record data that the merchandiser is departing from the target location (i.e., target location departure date).

The merchandiser then may proceed to second target location 810, whereupon these same steps are carried out to record arrival of the merchandiser at second target location 810, arrival and departure at the respective product displays 840, 842 and 844, and departure from second target location 810.

The second step of the preferred method includes transferring the target location arrival data, and preferably product display arrival departure data and target location departure data as well, from the storage device to the data center by remote data transmission. Such transmission, and the system and apparatus to carry it out, may include a number of different forms. They may, for example, include providing the marketing data as previously described from target locations 1 and 2 (800 and 810) to a data center 846 identical to data center 146, and specifically to a database computer 848 identical to database computer 148, using a telecommunication network. Examples of such telecommunication networks have been described previously herein and are fully applicable to this method and system. A specific example of such telecommunication network, for example, would include a cellular telephone network, or a so-called land line, such as a telephone, data, ISDN, or similar line or network. This data transmission step also may include use of a satellite communication system, for example, wherein the marketing data is transmitted from the respective target location to data center 846 via a communication satellite.

The method and system according to this aspect of the invention are not limited to the specific embodiment and apparatus shown and described with regard to FIG. 8. Other implementations may be adopted. For example, the token may include a fingerprint of the merchandiser. In this instance, the system would include a device for reading fingerprints, such as a fingerprint scanner, to uniquely identify the merchandiser. The fingerprint reader would be provided at first target location 800, for example, in lieu of or in addition to code reader 850, to record and store marketing data indicating the arrival of the merchandiser at the target location.

The token also may comprise a electromagnetic transmitter that transmits an electromagnetic signal. This could take the form, for example, of a radio frequency transmitter, such as is commonly used for garage door openers and similar applications. The merchandiser would carry the electromagnetic transmitter and, upon arrival at the target location, would actuate it to cause an electromagnetic signal to be transmitted from the transmitter to a reading device, such as an electromagnetic receiver, located at the target location, again, in addition to or in lieu of code reader 850.

The token also may assume the form of an optical or infrared transmitter that transmits optical or infrared signal to a corresponding reader or receiver at the target location. The reader or receiver would be used to read the optical or infrared signal transmitted by the transmitter at the hand of the merchandiser to record the arrival and/or departure of the merchandiser at the target location, or at product displays within the target location.

In accordance with yet another aspect of the invention, a marketing data collection method is provided for collecting marketing data pertaining to a merchandiser at a target location and transferring the marketing data to a data center. The method according to this aspect of the invention includes a first step of recording and storing arrival of the merchandiser at the target location in a storage device as target location arrival data, and a second step of automatically transferring the target location arrival data from the storage device to the data center.

The method optionally but preferably may include a step of recording and storing departure of the merchandiser from the target location in the storage device as target location departure data, and of similarly recording and storing arrival data indicating arrival and departure of the merchandiser at product displays within the target location or locations. In each such instance, the method would include automatically transferring the recorded and stored data to the data center. The data transfer step preferably is carried out using remote data transmission, for example, using a telecommunication network, a cellular telephone network, a satellite communication system, and the like.

In accordance with the preferred method and system according to this aspect of the invention, the step of recording and storing arrival and/or departure of the merchandiser at the target location and/or at individual product displays may be carried out in the manner described above. Similarly, the actual transmission of marketing data from the storage device to the data center may be carried out using one of more of the data transmission techniques and approaches described above.

In accordance with this method, the marketing data is automatically transferred. This automatic transfer may be done in a number of ways. For example, the storage device may be preprogrammed to transmit the stored marketing data upon entry of target location departure data, e.g., when the storage device records a target location identifier code as “departure” data, the system automatically establishes a communication link with database computer 848 at data center 846 and transfers the data.

Automatic transfer also may occur on a timed or periodic basis. The storage device, for example, may be preprogrammed to establish a communication link with data base computer 846 at predetermined times or time intervals, e.g., at 5:30 p.m. each business day.

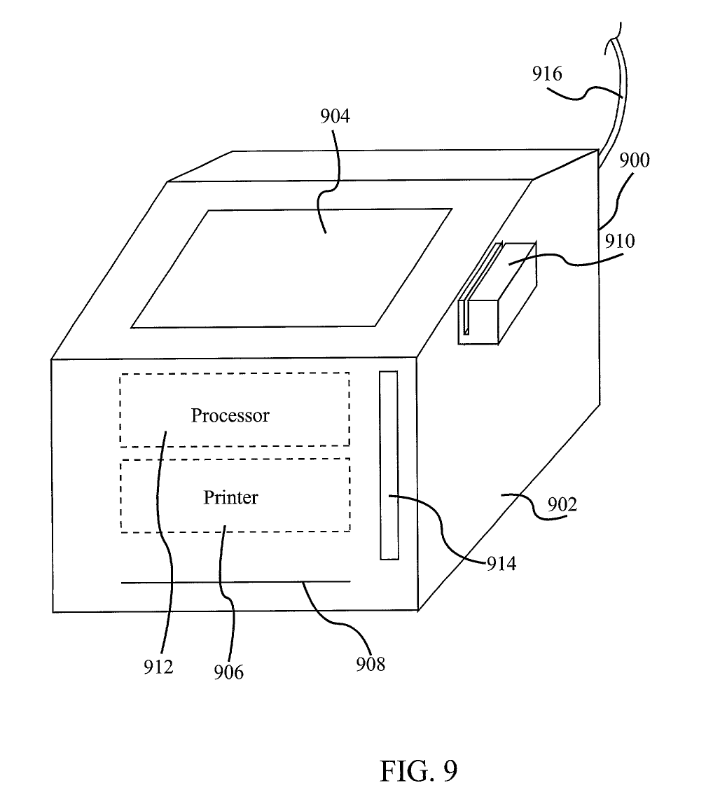

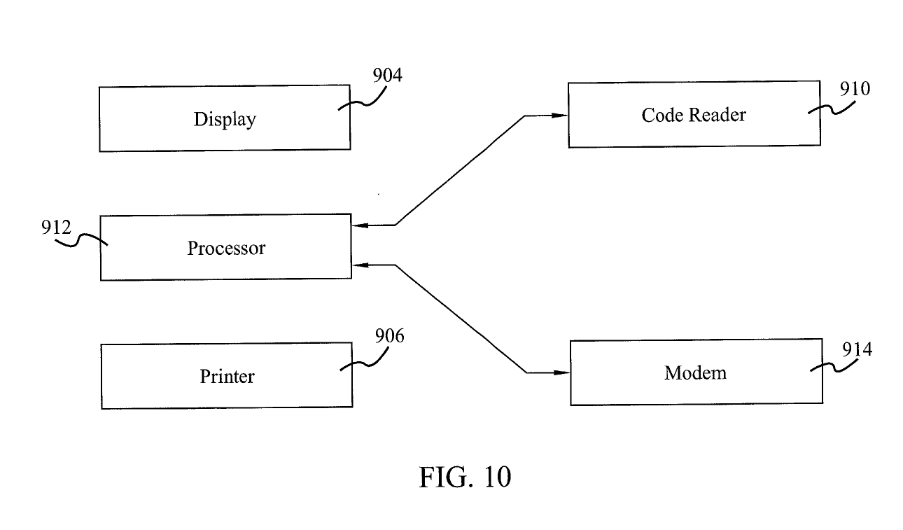

A system 900 according to a preferred embodiment of another aspect of the invention is illustrated in FIGS. 9 and 10. System 900 preferably would be located at a target location. More preferably, each target location of interest would house a system 900 as shown in FIG. 9. System 900 includes a cabinet 902 having a display 904, a printer 906 located within cabinet 902, a printer paper exit slot 908, a code reader 910, and a processor 912 including storage (RAM), a modem or network card 914, and a network or modem cable 916. An appropriate power supply, preferably using standard wall outlet electrical power, also is provided. Code reader 910 may take a number of forms, including those discussed above with regard to previous embodiments of the present invention. FIG. 10 provides a block diagram of system 900.

In this preferred embodiment, code reader 910 comprises a magnetic card reader for reading the data embodied in the magnetic data strip on the face or back of a magnetic card (the token), in the same manner that the magnetic strip on a credit card would be read. Code reader 910 includes associated circuitry for transforming this magnetic data as read by code reader 910 to a digital data signal that can be inputted into and read by processor 912. This information is stored in the RAM of processor 912. Code reader also may take other forms, for example, including but not limited to an optical bar code scanner, a password or data entry keypad, a fingerprint scanner, etc. Display 904 also may comprise a touch-screen monitor and thus be used as the code reader or data input device for recording the arrival, departure and/or presence of the merchandiser at the target location.

This stored data can then be transferred to the data center via line 916. As noted above, this may be done automatically at predetermined times, when predetermined conditions are met, or when queried or instructed to do so by a remote signal, e.g., from the data center. The data also may be transferred upon request made at the cabinet 902 or system 900 itself. A simple interface, such as a “Transfer” button, may be provided on the exterior of cabinet 902, for example, to carry out this data transfer function.

The systems as herein described may be used individually, or as integrated components of a larger system. Moreover, such systems may be adapted in known manner so they can interface with and interact with management systems at the target locations or elsewhere, for example, such as in store management, inventory control and/or purchasing systems.

In accordance with another aspect of the invention, a marketing data collection system is provided for collecting marketing data pertaining to a merchandiser at a target location, wherein the system can identify and record the arrival, departure and/or presence of the merchandiser at the target location automatically, without any overt act on the part of the merchandiser or any other individual. In accordance with a presently preferred embodiment according to this aspect of the invention, the system includes a geolocation positioning device in physical possession of the merchandiser. The geolocation positioning device automatically receives positioning signals, such as those broadcasted as part of the GPS system or the like. The device also includes a clock and a storage device, such as a random access memory, for time tagging and recording positioning data. The storage device also has programmed into it the geolocation of each of the target locations to be visited by the merchandiser. As the merchandiser travels to the target location, the positioning device carried by the merchandiser records the broadcasted positioning data and compares it to the prerecorded target location positions. When the positioning device determines that the merchandiser is within a predetermined range of the target location, e.g., 100 feet, it records the merchandiser's arrival or presence at that target location. This arrival or presence data is stored in the storage device, from where it can later be read out in a data transfer operation, for example, as described above.

In accordance with still another aspect of the invention, the arrival, departure and/or presence of the merchandiser can be automatically recorded, according to a presently preferred embodiment, by locating a broadcasting device at the target location, and by providing the merchandiser with a receiving device that receives the broadcasted signal and records and time tags the signal to confirm that the merchandiser in fact was physically present. The broadcasting device may take a number of forms. It may, for example, comprise a radio frequency transmitter located at the target location. The transmitter may, for example, be located at the entrance to the target location, at one or more product displays within the target location, on or in the products themselves or their packaging, etc. As the merchandiser enters the broadcast area of the transmitter, the receiver carried by the merchandiser receives the signal, time tags it, and stores the data to confirm that he or she was physically present at the location of the transmitter, e.g., at the target location, the product display area, etc.

Similarly, the broadcast transmitter may be carried by the merchandiser and the receiver may be located at the target location, the product display, etc. As the merchandiser physically passes into the area in which the receiver is located, the transmitter broadcasts its signal to the receiver, which time tags the information and stores it to confirm that the merchandiser was physically at the location of the receiver. The receivers preferably are at or within the desired target locations. In similar fashion, however, the receivers may be at locations so that the broadcasted signal as received by the receivers can locate the physical geolocation of the merchandiser. This general location information can be correlated with the locations of the target locations to determine or confirm that the merchandiser was physically present at the target location on a given date, at a given time, etc. This may be achieved by such techniques as triangulation.

In accordance with another aspect of the invention, the presence of a merchandiser at a target location can be confirmed by prestoring a device at the target location which the merchandiser uses at the target location to record his or her presence. In accordance with a presently preferred embodiment, a wheeled cart may be prestored at the target location. The cart would include a processor and storage device that would enable the merchandiser to indicate his or her physical presence at the cart, for example, by entering a password or code, scanning a bar code, etc., to identify himself or herself. This presence data (arrival, departure, etc.) could be transferred to the data center in a number of ways. It could, for example, be transmitted via a radio frequency link to a local computer or server at the target location, from which it could be transferred to the data center, for example, using the apparatus and/or techniques as disclosed herein above. The data also may be transferred via modem line or network link.

The device prepositioned at the target location also may include such things as a hand-held notebook or device that includes a clock, and which is capable of recording or indicating the presence of the merchandiser at the target location at which the device is located. The merchandiser, for example, might check the device out from a central location at the target location, use it as merchandiser activities are carried out at that location, and then return the device to the checkout center. The device then may be used to read out the presence data and transfer it to the data center.

The apparatus and method for identifying the merchandiser according to the various aspects of the invention are not necessarily limited to those described above with regard to the presently preferred but merely illustrative embodiments. The merchandiser, for example, may be identified by such means as the merchandiser's ocular characteristics (e.g., using a retinal scanner or like device), his or her voice characteristics (e.g., using a voice recognition system), facial appearance (e.g., using a pattern recognition system with facial appearance or characteristics prestored in it), handwriting or signature (e.g., using a handwriting exemplar pattern recognition system), hand dimension (e.g., as measured by an imaging system and pattern recognition system with prestored hand-dimension data), etc. Such tokens as holograms also may be used. It is also possible to use a password or code that would be provided to the merchandiser, and which he or she would use at the target locations to register his or presence there. It is not necessarily a requirement that the token or identification means uniquely or exhaustively identify a particular merchandiser. It may be appropriate or sufficient in some applications, for example, to merely confirm that a merchandiser was present at the target location at a particular date or time, or that a member of a particular merchandiser group or class was present. It also may be sufficient in a given application to merely identify a given merchandiser or group of merchandisers sufficiently that it is likely or probable that in fact it was that merchandiser or group, and that it is highly unlikely the system has not been deluded by having a third party or unauthorized party attempting to dupe the system by attempting to register the presence of the merchandiser without the merchandiser actually being present.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

1. A marketing data collection system for collecting marketing data pertaining to a merchandiser at a target location, said system comprising:
a processor located at the target location to receive and store information; and
a code reader incorporated with said processor, said code reader to receive input information from a merchandiser whereby upon input of said information the presence of the merchandiser at the processor is read and recorded in the processor.

2. The invention of claim 1 wherein said code reader is adapted to read a magnetic strip passed by the reader.

3. The invention of claim 1 wherein said code reader is adapted to read a bar code passed by said reader.

4. The invention of claim 1 further comprising a printer in connection with said processor whereby said printer can print information relative to the input of information through the code reader.

5. The invention of claim 1 further comprising a display in association with said processor, said display providing certain predetermined information to enable the merchandiser to input of information through the code reader.

6. The invention of claim 5 wherein the display is a touch screen and serves as the code reader whereby a merchandiser may input information through the touch screen to record the merchandisers presence at the processor.

7. The invention of claim 1 further comprising a transfer mechanism to transmit information from the processor to a data center upon occurrence of a predetermined event.

8. The invention of claim 7 wherein said predetermined event is one or more set times of the day at which transmission occurs.

9. The invention of claim 1 wherein the code reader is adapted to receive a first input relative to the arrival of a merchant in proximity to the processor and a second input relative to the departure of the merchandiser relative to the processor.

10. A marketing data collection system for collecting marketing data pertaining to a merchandiser at a target location, said system comprising:
a transmitter in a predetermined location;
a receiver in a second location; and
A storage device whereby one of said transmitter or receiver, in the possession of the merchandiser, upon entering a location within a predetermined region activates communication between the transmitter and receiver such that the presence of the merchandiser within the region is automatically recorded in the storage device.

11. The invention of claim 10 wherein the receiver is a geolocation positioning device.

12. The invention of claim 11 wherein the geolocation positioning device is preprogramed with one or more regions about one or more target locations.

13. The invention of claim 12 wherein the geolocation positioning device receives a broadcasted location from the transmitter when the geolocation device is within the region and said event is stored within the storage device.

14. The invention of claim 14 wherein the transmitter is a global positioning satellite.

15. The invention of claim 14 wherein the storage device is unitary with the receiver.

16. The invention of claim 13 wherein the storage device records said event and the time of its occurrence.

17. The invention of claim 10 wherein said storage device records the leaving of the receiver outside of the predetermined region.

18. The invention of claim 17 wherein the storage device records the time of day the receiver leaves the predetermined region.

19. The invention of claim 10 wherein the transmitter is at the target location and the receiver and storage device are with the merchandiser.

20. The invention of claim 19 wherein the storage device records the receipt of the transmission by the receiver from the transmitter and the time of said receipt.

21. The invention of claim 20 wherein the receiver and the storage device are unitary.

22. The invention of claim 21 where in the transmitter is a radio frequency transmitter.

23. The invention of claim 21 further comprising a product display unit and a plurality of packaged products in proximity to said display unit and wherein said transmitter is located in close proximity to said display unit.

24. The invention of claim 23 wherein said transmitter is located in a product package.

25. The invention of claim 10 wherein the receiver is at the target location and the transmitter is with the merchant.

26. The invention of claim 25 further comprising a plurality of target locations, each containing a receiver whereby said receivers upon receiving a signal from the transmitter triangulate to identify the position of the transmitter.

27. A marketing data collection method for collecting marketing data pertaining to a merchandiser at a target location comprising the following steps:
determining a predetermined region about a target location;
programming said predetermined region within a geolocation positioning device;
recording the position of said geolocation positioning device when it enters the predetermined region.

28. The method of claim 27 further comprising:
recording the removal of the geolocation positioning device outside of the predetermined region.

29. The invention of claim 28 further comprising:
recording the time of entry of the geolocation positioning device within the predetermined region and the time the geolocation positioning device exits the predetermined region.
